(19) United States
(12) Patent Application Publication
(10) Pub. No.: US 2026/0073410 A1
(43) Pub. Date: Mar. 12, 2026

(54) INFORMATION PROCESSING APPARATUS, INFORMATION PROCESSING METHOD, AND RECORDING MEDIUM

(71) Applicant: NEC Corporation, Tokyo (JP)

(72) Inventor: Yudai YAMAGUCHI, Tokyo (JP)

(73) Assignee: NEC Corporation, Tokyo (JP)

(21) Appl. No.: 19/311,275

(22) Filed: Aug. 27, 2025

(30) Foreign Application Priority Data
Sep. 9, 2024 (JP) 2024-155195

(51) Int. Cl. G06Q 30/0202

(52) U.S. Cl. CPC G06Q 30/0202

(57) ABSTRACT

An information processing apparatus includes at least one memory storing instructions, and at least one processor configured to execute the instructions to: acquire current status information related to a current status of cost related to distribution of a product, acquire assumed information including accuracy improvement information indicating a degree of improvement assumed for demand prediction accuracy regarding the product and current status improvement information indicating a degree of improvement assumed for the current status information, and estimate an effect amount indicating an effect due to improvement in the demand prediction accuracy as an amount of money based on the current status information and the assumed information.

This application is based upon and claims the benefit of priority from Japanese patent application No. 2024-155195, filed on Sep. 9, 2024, the disclosure of which is incorporated herein in its entirety by reference.

### TECHNICAL FIELD

The present disclosure relates to an information processing apparatus, an information processing method, and a recording medium.

### BACKGROUND ART

In recent years, it is important for a company that sells a product to predict the demand for the product. For example, JP 2022-76421 A describes a technique for improving the accuracy of product demand prediction.

### SUMMARY

An exemplary object thereof is to provide a technology for presenting a specific effect due to the improvement in the accuracy of demand prediction to a user in a comprehensible manner.

An information processing apparatus according to an exemplary aspect of the present disclosure includes at least one memory storing instructions, and at least one processor configured to execute the instructions to: acquire current status information related to a current status of cost related to distribution of a product, acquire assumed information including accuracy improvement information indicating a degree of improvement assumed for demand prediction accuracy regarding the product and current status improvement information indicating a degree of improvement assumed for the current status information, and estimate an effect amount indicating an effect due to improvement in the demand prediction accuracy as an amount of money based on the current status information and the assumed information.

An information processing method according to an exemplary aspect of the present disclosure includes acquiring current status information related to a current status of cost related to distribution of a product, acquiring assumed information including accuracy improvement information indicating a degree of improvement assumed for demand prediction accuracy regarding the product and current status improvement information indicating a degree of improvement assumed for the current status information, and estimating an effect amount indicating an effect due to improvement in the demand prediction accuracy as an amount of money based on the current status information and the assumed information.

A non-transitory computer-readable recording medium storing a program according to an exemplary aspect of the present disclosure causes a computer to execute processing comprising acquiring current status information related to a current status of cost related to distribution of a product, acquiring assumed information including accuracy improvement information indicating a degree of improvement assumed for demand prediction accuracy regarding the product and current status improvement information indicating a degree of improvement assumed for the current status information, and estimating an effect amount indicating an effect due to improvement in the demand prediction accuracy as an amount of money based on the current status information and the assumed information.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating a configuration of an information processing apparatus according to the present disclosure;

FIG. 2 is a flowchart illustrating a flow of an information processing method according to the present disclosure;

FIG. 3 is a block diagram illustrating a configuration of an information processing apparatus according to the present disclosure;

FIG. 4 is a flowchart illustrating a flow of an information processing method according to the present disclosure;

FIG. 5 is a diagram illustrating an example of a display according to the present disclosure;

FIG. 6 is a diagram illustrating an example of a display according to the present disclosure; and

FIG. 7 is a block diagram illustrating a hardware configuration of a computer that functions as devices according to the present disclosure.

### EXAMPLE EMBODIMENT

Hereinafter, example embodiments of the present disclosure will be described. However, the present disclosure is not limited to the exemplary example embodiments to be described below, and various modifications can be made within the scope described in the claims. For example, example embodiments obtained by appropriately combining techniques (some or all of things or methods) adopted in the exemplary example embodiments to be described below can also be included in the scope of the present disclosure. Example embodiments obtained by appropriately omitting some of the techniques adopted in the exemplary example embodiments to be described below can also be included in the scope of the present disclosure. Advantages mentioned in the exemplary example embodiments to be described below are examples of advantages expected in the exemplary example embodiments, and do not define extensions of the present disclosure. In other words, example embodiments that do not achieve the effects mentioned in the exemplary example embodiments to be described below can also be included in the scope of the present disclosure.

### First Exemplary Example Embodiment

A first exemplary example embodiment that is an example of an example embodiment of the present disclosure will be described in detail with reference to the drawings. The present exemplary example embodiment is a basic form of each exemplary example embodiment to be described below. An application range of each technique adopted in the present exemplary example embodiment is not limited to the present exemplary example embodiment. That is, each technique adopted in the present exemplary example embodiment can also be adopted in the other exemplary example embodiments included in the present disclosure within a range in which no particular technical problem occurs. Each technology illustrated in the drawings referred to for describing the present exemplary example embodiment can also be adopted in other exemplary example embodiments included in the present disclosure within a range in which no particular technical problems occur.

### (Configuration of Information Processing Apparatus 1)

An information processing apparatus 1 is an apparatus for indicating the effect due to improvement in the demand prediction accuracy of the product to a user in a comprehensible manner. Here, the product targeted by the information processing apparatus 1 may be, for example, a part or all of products handled by a target company (an example of the user).

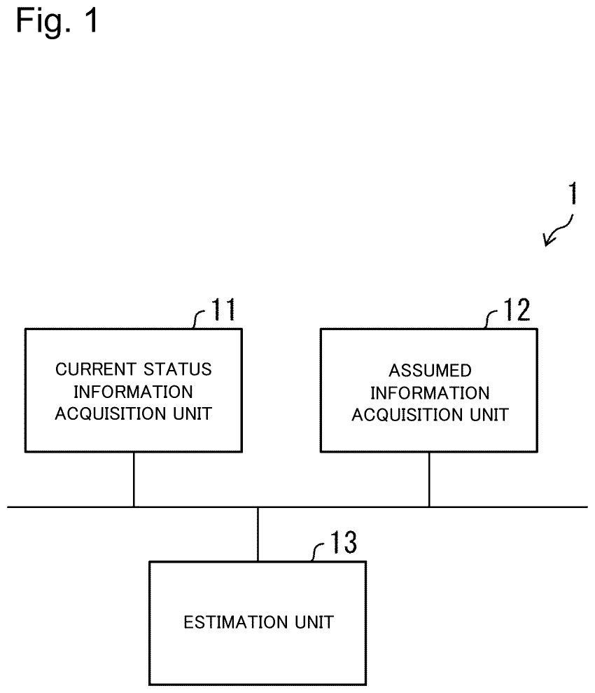

A configuration of an information processing apparatus 1 will be described with reference to FIG. 1. FIG. 1 is a block diagram illustrating a configuration of the information processing apparatus 1. As illustrated in FIG. 1, the information processing apparatus 1 includes a current status information acquisition unit 11, an assumed information acquisition unit 12, and an estimation unit 13. The current status information acquisition unit 11 is an example of a configuration for implementing the current status information acquisition means. The assumed information acquisition unit 12 is an example of a configuration for implementing the assumed information acquisition means. The estimation unit 13 is an example of a configuration for implementing the estimation means.

The current status information acquisition unit 11 acquires current status information related to a current status of cost related to distribution of a product. For example, the current status information may include a cost itself related to distribution of a product, or may include various types of information affecting the cost. Examples of the cost itself related to distribution of consumption include, but are not limited to, storage cost, transportation cost, and labor cost. Examples of various types of information that affect the cost include, but are not limited to, a stockout rate. Note that the current status information is desirably the latest information (In other words, the latest information), but is not necessarily limited to the latest information. Furthermore, a part or all of the current status information may be acquired by input from the user, or may be read from a database.

The assumed information acquisition unit 12 acquires assumed information including accuracy improvement information indicating a degree of improvement assumed for demand prediction accuracy regarding the product and current status improvement information indicating a degree of improvement assumed for the current status information. The demand prediction accuracy indicates how close a demand prediction value indicating a result of demand prediction of a product is to a demand actual result value indicating a demand actual result of the product. The accuracy improvement information may be, for example, a degree of improvement assumed in the demand prediction accuracy in a case where an action for improving the demand prediction accuracy is performed in the target company. The current status improvement information may be, for example, a degree of improvement assumed in the current status information in a case where the demand prediction accuracy is improved.

Furthermore, the assumed information may be acquired through input from the user. For example, the assumed information may be information input by consultation between the user of the target company and an expert of demand prediction. Note that the assumed information is not limited to the input from the user, and information determined in advance or information calculated by a predetermined algorithm may be acquired.

The estimation unit 13 estimates an effect amount indicating an effect due to improvement in the demand prediction accuracy as an amount of money based on the current status information and the assumed information. For example, the effect amount may include cost expected to be reduced due to improvement in demand prediction accuracy, revenue expected to be increased due to improvement in demand prediction accuracy, and the like. For example, the estimation unit 13 may calculate the effect amount using an estimation model that outputs the effect amount using the current status information and the assumed information as inputs. The estimation model may be configured by one or a plurality of functions, or may be a machine learning model generated by machine learning.

### (Effects of Information Processing Apparatus 1)

As described above, the information processing apparatus 1 employs a configuration including: the current status information acquisition unit 11 for acquiring current status information related to a current status of cost related to distribution of a product; the assumed information acquisition unit 12 for acquiring assumed information including accuracy improvement information indicating a degree of improvement assumed for demand prediction accuracy regarding the product and current status improvement information indicating a degree of improvement assumed for the current status information; and the estimation unit 13 for estimating an effect amount indicating an effect due to improvement in the demand prediction accuracy as an amount of money based on the current status information and the assumed information. Here, such an effect amount is easy for the user to understand as a specific effect due to improvement in demand prediction accuracy. Therefore, according to the information processing apparatus 1, it is possible to obtain an effect that a specific effect due to improvement in demand prediction accuracy can be presented to the user in a comprehensible manner.

### (Flow of Information Processing Method S1)

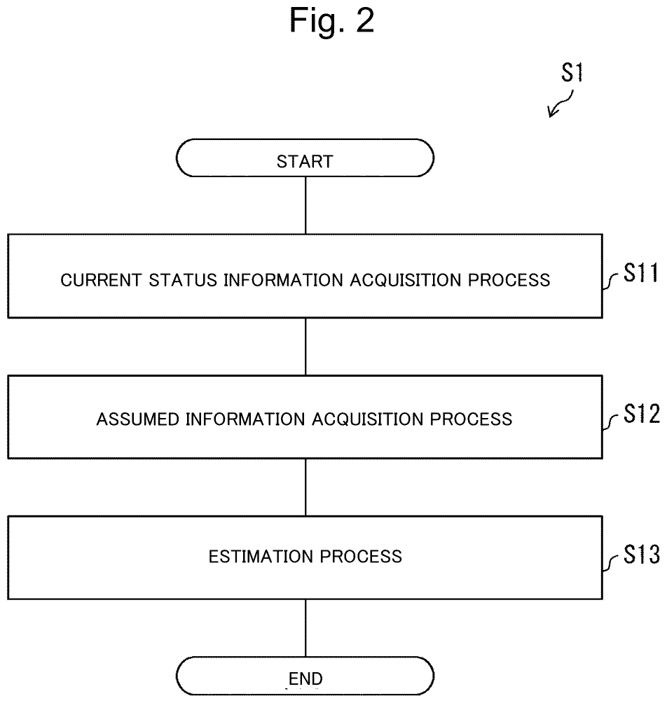

A flow of an information processing method S1 will be described with reference to FIG. 2. FIG. 2 is a flowchart illustrating the flow of the information processing method S1. For example, in a case where the information processing apparatus 1 described above includes at least one processor, the information processing apparatus 1 executes the information processing method S1. As illustrated in FIG. 2, the information processing method S1 includes a current status information acquisition process S11, an assumed information acquisition process S12, and an estimation process S13.

In the current status information acquisition process S11, at least one processor (for example, the current status information acquisition unit 11) acquires the current status information related to the current status of the cost related to the distribution of the product. Details of the current status information acquisition process S11 are as those of the current status information acquisition unit 11 described above, and thus description thereof will not be repeated.

In the assumed information acquisition process S12, the at least one processor acquires assumed information including accuracy improvement information indicating a degree of improvement assumed for demand prediction accuracy regarding the product and current status improvement information indicating a degree of improvement assumed for the current status information. Details of the assumed information acquisition process S12 are as those of the assumed information acquisition unit 12 described above, and thus description thereof will not be repeated.

In the estimation process S13, the at least one processor estimates an effect amount indicating an effect due to improvement in the demand prediction accuracy as an amount of money based on the current status information and the assumed information. Details of the estimation process S13 are as those of the estimation unit 13 described above, and thus description thereof will not be repeated.

### (Effect of Information Processing Method S1)

As described above, the information processing method S1 employs a configuration including: the current status information acquisition process S11 in which at least one processor acquires current status information related to a current status of cost related to distribution of a product; the assumed information acquisition process S12 in which the at least one processor acquires assumed information including accuracy improvement information indicating a degree of improvement assumed for demand prediction accuracy regarding the product and current status improvement information indicating a degree of improvement assumed for the current status information; and the estimation process S13 in which the at least one processor estimates an effect amount indicating an effect due to improvement in the demand prediction accuracy as an amount of money based on the current status information and the assumed information. Therefore, according to the information processing method S1, the same effects as those of the information processing apparatus 1 can be obtained.

### Second Exemplary Example Embodiment

A second exemplary example embodiment that is an example of an example embodiment of the present disclosure will be described in detail with reference to the drawings. Constituents that have the same functions as the constituents described in the above-described exemplary example embodiment are denoted by the same reference numerals, and the description of the constituents will be appropriately omitted. An application range of each technique adopted in the present exemplary example embodiment is not limited to the present exemplary example embodiment. That is, each technique adopted in the present exemplary example embodiment can also be adopted in the other exemplary example embodiments included in the present disclosure within a range in which no particular technical problem occurs. Each technique illustrated in each of the drawings referred to for describing the present exemplary example embodiment can be employed in the other exemplary example embodiments included in the present disclosure within the scope in which no particular technical problem occurs.

### (Configuration of Information Processing Apparatus 1A)

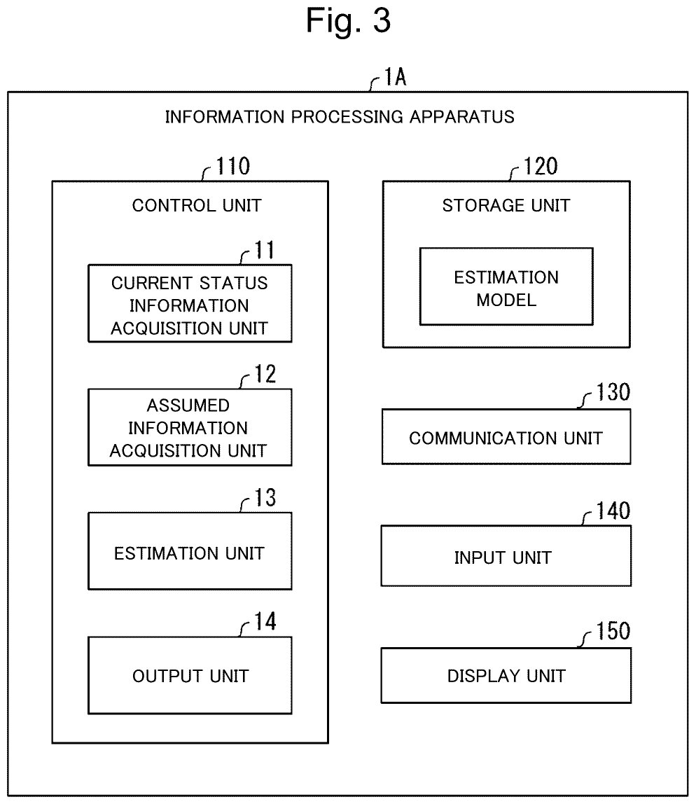

Next, a configuration of an information processing apparatus 1A will be described with reference to FIG. 3. FIG. 3 is a block diagram illustrating the configuration of the information processing apparatus 1A. The information processing apparatus 1A includes a control unit 110, a storage unit 120, a communication unit 130, an input unit 140, and a display unit 150. The control unit 110 includes an output unit 14, in addition to the current status information acquisition unit 11, the assumed information acquisition unit 12, and the estimation unit 13 included in the information processing apparatus 1. The output unit 14 is an example of a configuration for implementing the output means. The storage unit 120 stores an estimation model.

The communication unit 130 communicates with a device outside the information processing apparatus 1A via a communication line. The communication unit 130 transmits data supplied from the control unit 110 to another device, and supplies data received from another device to the control unit 110.

The input unit 140 is a configuration for receiving an input to the information processing apparatus 1A, and may include, as an example, an input device such as a keyboard, a mouse, a touch panel, a camera, or a microphone. The display unit 150 is a configuration for displaying a screen output from the information processing apparatus 1A, and may include a display as an example. The input unit 140 and the display unit 150 may be integrally formed as a touch panel or the like. One or both of the input unit 140 and the display unit 150 are not limited to being built in the user terminal 20, and may be connected to the outside via an interface such as a universal serial bus (USB), for example.

### (Functional Block of Control Unit 110)

The current status information acquisition unit 11 is configured similarly to that of the first exemplary example embodiment. In the present exemplary example embodiment, the current status information acquired by the current status information acquisition unit 11 includes a part or all of a sales scale, a current stockout rate, a downward fluctuation composition ratio of demand, a cost rate, a production/procurement lead time, a storage related cost, a transportation related cost, and a labor related cost.

The sales scale may be, for example, an annual sales amount, or may be a sales amount in another unit period. The downward fluctuation composition ratio of the demand indicates the ratio of the actual performance below the demand prediction. The cost rate indicates a ratio of a cost price to a sales amount of the product. The production/procurement lead time includes a period from the start of production to completion and a period required for delivery from the production place to the consumption place, and may be a statistical value (Average value, minimum value, maximum value) of the production/procurement lead time of each product when there is a plurality of products. The storage related cost indicates a cost related to storage of the product, and may include, for example, a cost related to a storage location (warehouse or the like). Specific examples of the transportation related cost include, but are not limited to, intra-company transportation cost, sales transportation cost, and the like. The labor related cost includes the labor cost related to the demand prediction of the product. Specific examples of the labor related cost include, but are not limited to, a unit price of a manager related to demand prediction, a unit price of a demand planner related to demand prediction, a time related to calculation of demand prediction accuracy, a predicted work time of the manager or the demand planner, and the number of the demand planners.

The assumed information acquisition unit 12 is configured similarly to that of the first exemplary example embodiment. In the present exemplary example embodiment, of the assumed information acquired by the assumed information acquisition unit 12, the accuracy improvement information includes an assumed improvement rate assumed for the demand prediction accuracy by each of a plurality of actions that can be performed for improving the demand prediction accuracy. Hereinafter, the “assumed improvement rate assumed for the demand prediction accuracy” is also referred to as an “assumed improvement rate of the demand prediction accuracy”.

Examples of the action include, but are not limited to, utilization of an accuracy management function for managing the demand prediction accuracy, utilization of a demand fluctuation alert function for presenting an alert based on demand fluctuation, and utilization of an LLM error analysis function for supporting error analysis of demand prediction by LLM (large-scale language model). For example, in the accuracy management function, a screen visualizing various indexes for managing the demand prediction accuracy may be presented to the user terminal. In addition, in the demand fluctuation alert function, an alert may be presented in a case where the various indexes satisfy the conditions. Furthermore, for example, in the LLM error analysis function, an interpretation example using LLM for the various indexes may be presented. In addition, other examples of the action include sophistication of the demand prediction model, introduction of the demand prediction system, and the like. However, the type of the action and the content thereof are not limited to the example described above.

Furthermore, in the present exemplary example embodiment, the current status improvement information among the assumed information acquired by the assumed information acquisition unit 12 includes a part or all of the assumed improvement rate of a stockout and the assumed reduction rate of the working time. The assumed improvement rate of the stockout indicates a degree of improvement expected for the stockout rate if the demand prediction accuracy is improved. The assumed reduction rate of the working time indicates the degree to which the working time related to the demand prediction is reduced if the demand prediction accuracy is improved.

Furthermore, the assumed information acquired by the assumed information acquisition unit 12 may include other information related to the cost related to the distribution of the product, in addition to the accuracy improvement information and the current status improvement information. Examples of the other information include, but are not limited to, a degree to which a stockout leads to an opportunity loss, a product procurement/transportation cost, and the like.

Note that, in a case where both the current status information and the assumed information are acquired by the user's input, the current status information is information that can be easily input by the user based on a record and the like, whereas the assumed information is information that needs to be estimated and input because it is in the future or it is difficult to obtain the record. For example, such estimation may be performed by a human or may be performed by a computer.

The estimation unit 13 is configured similarly to that of the first exemplary example embodiment. In the present exemplary example embodiment, the estimation unit 13 estimates the effect amount for each of the plurality of actions. Since the details of the action are as described above, the description thereof will not be repeated. The estimation unit 13 estimates the effect amount for each of the plurality of effects. Here, the effect due to improvement in the demand prediction accuracy includes, as a plurality of effects, a part or all of an effect due to reducing an opportunity loss, an effect due to reducing an inventory, an effect due to reducing a storage/distribution cost, and an effect due to improving operation efficiency. Note that the estimation unit 13 estimates the effect amount by using an estimation model to be described later.

The output unit 14 outputs the effect amount. For example, the output unit 14 may display a screen including the effect amount on the display unit 150. Furthermore, for example, the output unit 14 may output a breakdown of the effect amount based on the plurality of actions. Furthermore, for example, the output unit 14 may output a breakdown of the effect amount based on the plurality of effects.

### (Estimation Model)

The estimation model is a model that outputs the effect amount using the current status information and the assumed information as inputs, and may be, for example, a set of function expressions or a machine learning model. For example, the estimation model may be configured to output the effect amount for each of the plurality of actions. The estimation model may be configured to output the effect amount for each of the plurality of effects.

### (Flow of Information Processing Method S1A)

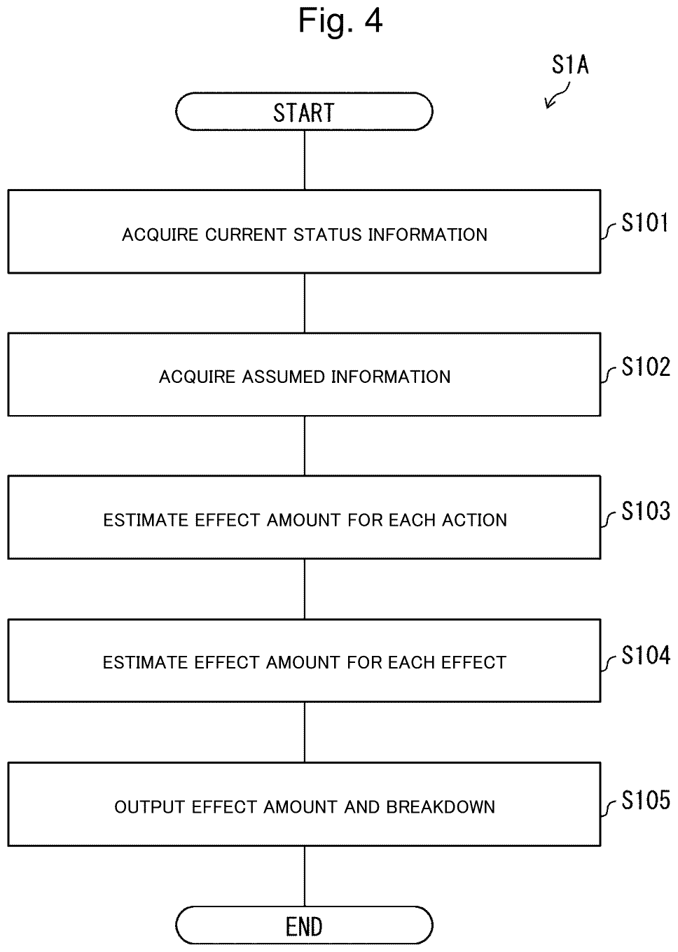

The information processing apparatus 1A configured as described above executes the information processing method SIA. FIG. 4 is a flowchart illustrating a flow of the information processing method SIA. As illustrated in FIG. 4, the information processing method SIA includes steps S101 to S105.

Step S101 is an example of the current status information acquisition process. In Step S101, the current status information acquisition unit 11 acquires the current status information. Step S102 is an example of the assumed information acquisition process. In Step S102, the assumed information acquisition unit 12 acquires the assumed information. Note that each process of steps S101 and S102 is not limited to be executed in this order, and may be executed in a different order or at least partially in parallel.

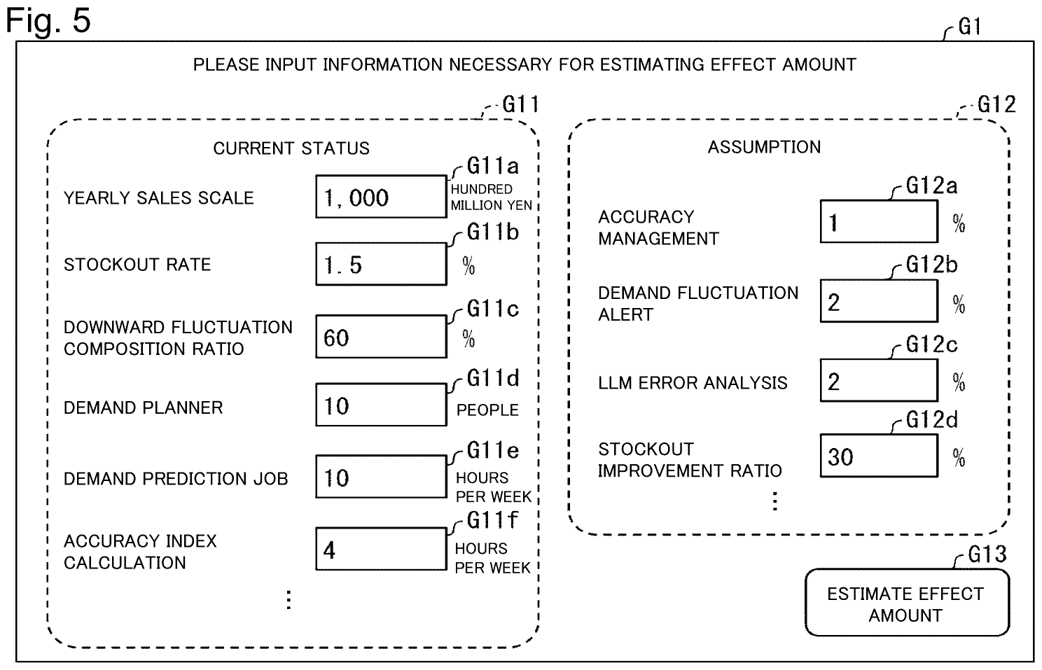

FIG. 5 is a diagram illustrating an example of a screen displayed on the display unit 150 in steps S101 to S102. In the screen example G1 illustrated in FIG. 5, an area G11 is an area for inputting current status information. An area G12 is an area for inputting the assumed information.

Input objects G11a to G11f are, for example, text fields, and specifically, the following current status information is input thereto. The annual sales scale is input to the input object G11a. The current stockout rate is input to the input object G11b. The downward fluctuation composition ratio of the demand is input to the input object G11c. The number of the demand planners is input to the input object G11d. The weekly working time related to the demand prediction is input to the input object G11e. The time related to the calculation of the index for managing the demand prediction accuracy is input to the input object G11f. The input objects G11a to G11f exemplified for the area G11 are examples, and other input objects for inputting the current status information may be included in the area G11. In addition, the input objects G11a to G11f are not limited to text fields, and may be numerical value selection lists or the like, but are not limited thereto.

The input objects G12a to G12d are, for example, text fields, and specifically, the following assumed information is input thereto. The assumed improvement rate of the demand prediction accuracy for a case where the accuracy management function is used as an action is input to the input object G12a. The assumed improvement rate of the demand prediction accuracy for a case where the demand fluctuation alert function is used as an action is input to the input object G12b. The assumed improvement rate of the demand prediction accuracy for a case where the LLM error analysis function is used as an action is input to the input object G12c. To the input object G12d, an assumed improvement rate of a stockout in a case where the demand prediction accuracy is improved is input. The input objects G12a to G12d exemplified for the area G12 are examples, and other input objects for inputting the assumed information may be included in the area G12. In addition, the input objects G12a to G12d are not limited to text fields, and may be an option list from which a desired option can be selected or the like, but are not limited thereto.

Furthermore, in the screen example G1, the operation object G13 receives an operation for instructing estimation of the effect amount. The screen example G1 has been described above, and the description of Step S103 and subsequent steps will be continued with reference to FIG. 4 again.

Steps S103 and S104 in FIG. 4 are examples of the estimation process. In Step S103, the estimation unit 13 estimates the effect amount for each of the plurality of actions. As an example, the estimation unit 13 inputs the current status information and the assumed information to the estimation model to obtain the effect amount for each action output from the estimation model.

In Step S104, the estimation unit 13 estimates the effect amount for each of the plurality of effects. As an example, the estimation unit 13 inputs the current status information and the assumed information to the estimation model to obtain the effect amount for each effect output from the estimation model. Note that each process of steps S103 and S104 is not limited to be executed in this order, and may be executed in a different order or at least partially in parallel.

Step S105 is an example of the output process. In Step S105, the output unit 14 outputs the effect amount and a breakdown of the effect amount. For example, the output unit 14 may output a breakdown of the effect amount based on each action, a breakdown of the effect amount based on each effect, and a sum of these amounts of effect.

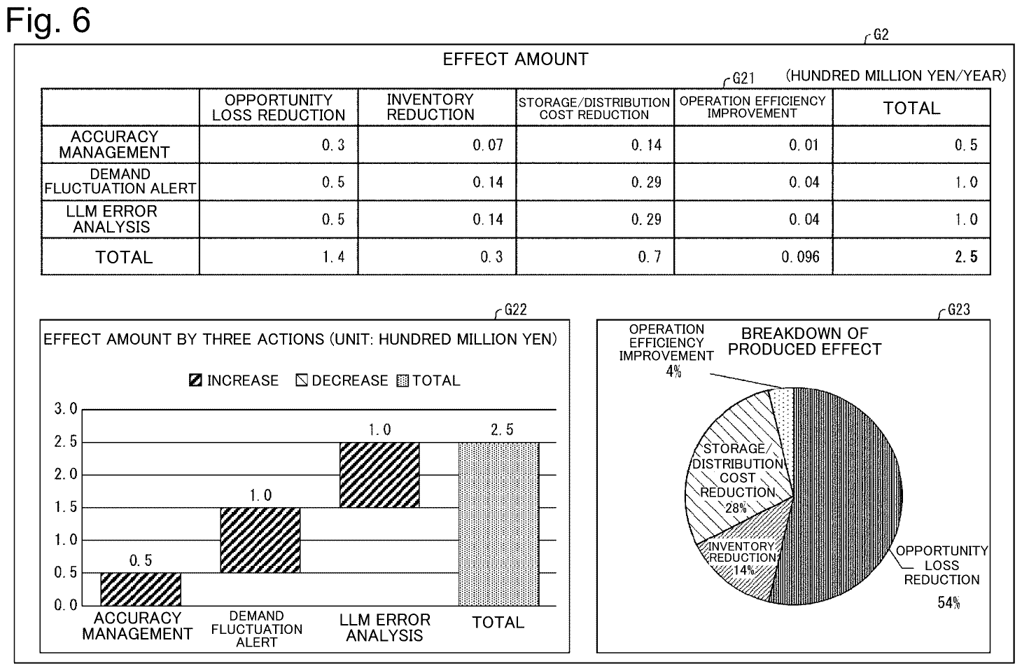

FIG. 6 is a diagram illustrating an example of a screen displayed on the display unit 150 in Step S105. The screen example 2 illustrated in FIG. 6 is displayed in response to acceptance of an operation by the operation object G13 in the screen example G1. That is, when the operation object G13 is operated, the screen of the display unit 150 transitions from the screen example G1 to the screen example G2. In the screen example G2, a table G21 is a table showing a breakdown and a total of the effect amount with a plurality of actions on the vertical axis and a plurality of effects on the horizontal axis. In the screen example G2, the utilization of the accuracy management function, the utilization of the demand fluctuation alert function, and the utilization of the LLM error analysis function described above are applied as the plurality of actions. The effect due to reducing an opportunity loss, the effect due to reducing an inventory, the effect due to reducing a storage/distribution cost, and the effect due to improving operation efficiency, which are described above, are applied as the plurality of effects. In addition, the graph G22 visualizes a breakdown of the effect amount for each action based on the table G21. In addition, the graph G23 visualizes a breakdown of the effect amount for each effect based on the table G21. With the screen example G2, the user can recognize each of a plurality of effects obtained by performing each action for improving the demand prediction accuracy in detail as a specific amount of money.

Note that the estimation unit 13 may estimate the effect amount for each predetermined classification, and the output unit 14 may output the effect amount of the classification that affects the balance sheet and the effect amount of the classification that affects the income statement in the predetermined classification in a distinguishable manner. For example, the predetermined classification may be classification by the above-described action or classification by the above-described effect. For example, in Table G21 of the screen example G2, the cells affecting the balance sheet and the cells affecting the income statement may be displayed in different display modes (for example, different colors, different patterns, etc.).

### (Effects of Information Processing Apparatus)

As described above, the information processing apparatus 1A further includes the output unit 14 that outputs the effect amount, and employs a configuration in which: the accuracy improvement information includes an assumed improvement rate assumed for the demand prediction accuracy by each of a plurality of actions that can be performed for improving the demand prediction accuracy; the estimation unit 13 estimates the effect amount for each of the plurality of actions; and the output unit 14 outputs a breakdown of the effect amount based on the plurality of actions. Therefore, according to the information processing apparatus 1A, in addition to the effects obtained by the information processing apparatus 1, it is possible to obtain an effect that, in a case where the user performs each action for improving the demand prediction accuracy, the user can specifically recognize how much effect is obtained by each action as the amount of money.

The information processing apparatus 1A further includes the output unit 14 that outputs the effect amount, and employs a configuration in which: the effect includes, as a plurality of effects, a part or all of an effect of reducing an opportunity loss, an effect of reducing an inventory, an effect of reducing a storage/distribution cost, and an effect of improving operation efficiency; the estimation unit 13 estimates the effect amount for each of the plurality of effects; and the output unit 14 outputs a breakdown of the effect amount based on the plurality of effects. Therefore, according to the information processing apparatus 1A, in addition to the effects obtained by the information processing apparatus 1, it is possible to obtain an effect that the user can specifically recognize how much of each of the plurality of effects is obtained by the improvement in the demand prediction accuracy as the amount of money.

The information processing apparatus 1A further includes the output unit 14 that outputs the effect amount, and employs a configuration in which: the estimation unit 13 estimates the effect amount for each predetermined classification; and the output unit 14 distinguishably outputs, among the classifications, the effect amount of a classification that affects a balance sheet and the effect amount of a classification that affects an income statement. Therefore, according to the information processing apparatus 1A, in addition to the effects obtained by the information processing apparatus 1, it is possible to obtain an effect that the user can specifically recognize how much effect that affects the balance sheet and the income statement is obtained by the improvement in the demand prediction accuracy as the amount of money.

The information processing apparatus 1A employs a configuration in which the current status information includes a part or all of a sales scale, a current stockout rate, a downward fluctuation composition ratio of demand, a cost rate, a production/procurement lead time, a storage related cost, a transportation related cost, and a labor related cost. Therefore, according to the information processing apparatus 1A, in addition to the effects achieved by the information processing apparatus 1, it is possible to achieve an effect that the effect amount can be estimated more accurately.

The information processing apparatus 1A employs a configuration in which the current status improvement information includes a part or all of an assumed improvement rate of a stockout and an assumed reduction rate of working time. Therefore, according to the information processing apparatus 1A, in addition to the effects achieved by the information processing apparatus 1, it is possible to achieve an effect that the effect amount can be estimated more accurately.

### (Modification)

The information processing apparatuses 1 and 1A are not limited to one computer, and may be configured by a plurality of computers. For example, the information processing apparatuses 1, 1A may include a server and a user terminal connected via a network. In this case, for example, the user terminal may acquire the current status information and the assumed information and transmit the current status information and the assumed information to the server, the server may transmit the effect amount estimated based on the current status information and the assumed information to the user terminal, and the user terminal may display the effect amount.

### [Example of Implementation by Software]

Some or all of the functions of the information processing apparatuses 1 and 1A (hereinafter, also referred to as “each of the above apparatuses”) may be implemented by hardware such as an integrated circuit (an IC chip) or may be implemented by software.

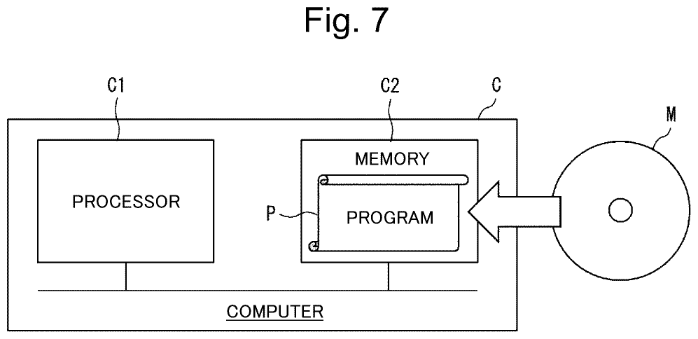

In the latter case, each of the above apparatuses is implemented by, for example, a computer that executes a command of a program which is software for implementing each function. An example of such a computer (hereinafter, referred to as a computer C) is illustrated in FIG. 7. FIG. 7 is a block diagram illustrating a hardware configuration of the computer C functioning as each of the above devices.

The computer C includes at least one processor C1 and at least one memory C2. A program P causing the computer C to operate as each of the above apparatuses is recorded in the memory C2. In the computer C, the processor C1 reads the program P from the memory C2 and executes the program P to implement each function of each of the above apparatuses.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the program P at the time of execution and temporarily storing various types of data. The computer C may further include a communication interface for transmitting and receiving data to and from other devices. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above apparatuses may be implemented by one processor provided in one computer, may be implemented in cooperation with a plurality of processors provided in one computer, or may be implemented in cooperation with a plurality of processors provided in a plurality of computers, respectively. The program causing each of the above apparatuses to implement each of the above functions may be stored in one memory provided in one computer, may be stored in a distributed manner in a plurality of memories provided in one computer, or may be stored in a distributed manner in a plurality of memories provided in a plurality of computers, respectively.

### [Supplementary Note A]

The present disclosure includes techniques described in the following supplementary notes. However, the present disclosure is not limited to the techniques described in the following supplementary notes, and various modifications can be made within the scope described in the claims.

### (Supplementary Note A1)

An information processing apparatus including:
a current status information acquisition means for acquiring current status information related to a current status of cost related to distribution of a product;
an assumed information acquisition means for acquiring assumed information including accuracy improvement information indicating a degree of improvement assumed for demand prediction accuracy regarding the product and current status improvement information indicating a degree of improvement assumed for the current status information; and
an estimation means for estimating an effect amount indicating an effect due to improvement in the demand prediction accuracy as an amount of money based on the current status information and the assumed information.

### (Supplementary Note A2)

The information processing apparatus according to Supplementary Note A1, further including an output means for outputting the effect amount, wherein:
the accuracy improvement information includes an assumed improvement rate assumed for the demand prediction accuracy by each of a plurality of actions that can be performed for improving the demand prediction accuracy;
the estimation means estimates the effect amount for each of the plurality of actions; and
the output means outputs a breakdown of the effect amount based on the plurality of actions.

### (Supplementary Note A3)

The information processing apparatus according to Supplementary Note A1 or A2, further including an output means for outputting the effect amount, wherein:
the effect includes, as a plurality of effects, a part or all of an effect due to reducing an opportunity loss, an effect due to reducing an inventory, an effect due to reducing a storage/distribution cost, and an effect due to improving operation efficiency;
the estimation means estimates the effect amount for each of the plurality of effects; and
the output means outputs a breakdown of the effect amount based on the plurality of effects.

### (Supplementary Note A4)

The information processing apparatus according to any one of Supplementary Notes A1 to A3, further including an output means for outputting the effect amount, wherein:
the estimation means estimates the effect amount for each predetermined classification; and
the output means distinguishably outputs, among the classifications, the effect amount of a classification that affects a balance sheet and the effect amount of a classification that affects an income statement.

### (Supplementary Note A5)

The information processing apparatus according to any one of Supplementary Notes A1 to A4, wherein the current status information includes a part or all of a sales scale, a current stockout rate, a downward fluctuation composition ratio of demand, a cost rate, a production/procurement lead time, a storage related cost, a transportation related cost, and a labor related cost.

### (Supplementary Note A6)

The information processing apparatus according to any one of Supplementary Notes A1 to A5, wherein the current status improvement information includes a part or all of an assumed improvement rate of a stockout and an assumed reduction rate of working time.

### [Supplementary Note B]

The present disclosure includes techniques described in the following supplementary notes. However, the present disclosure is not limited to the techniques described in the following supplementary notes, and various modifications can be made within the scope described in the claims.

### (Supplementary Note B1)

An information processing method including:
a current status information acquisition process in which at least one processor acquires current status information related to a current status of cost related to distribution of a product;
an assumed information acquisition process in which the at least one processor acquires assumed information including accuracy improvement information indicating a degree of improvement assumed for demand prediction accuracy regarding the product and current status improvement information indicating a degree of improvement assumed for the current status information; and
an estimation process in which the at least one processor estimates an effect amount indicating an effect due to improvement in the demand prediction accuracy as an amount of money based on the current status information and the assumed information.

### (Supplementary Note B2)

The information processing method according to Supplementary Note B1 further comprising:
an output process in which the at least one processor outputs the effect amount; wherein
the accuracy improvement information includes an assumed improvement rate assumed for the demand prediction accuracy by each of a plurality of actions that can be performed for improving the demand prediction accuracy;
in the estimation process, the at least one processor estimates the effect amount for each of the plurality of actions; and
in the output process, the at least one processor outputs a breakdown of the effect amount based on the plurality of actions.

### (Supplementary Note B3)

The information processing method according to Supplementary Note B1 or B2 further comprising:
an output process in which the at least one processor outputs the effect amount, wherein
the effect includes, as a plurality of effects, a part or all of an effect due to reducing an opportunity loss, an effect due to reducing an inventory, an effect due to reducing a storage/distribution cost, and an effect due to improving operation efficiency;
in the estimation process, the at least one processor estimates the effect amount for each of the plurality of effects; and
in the output process, the at least one processor outputs a breakdown of the effect amount based on the plurality of effects.

### (Supplementary Note B4)

The information processing method according to any one of Supplementary Notes B1 to B3 further comprising:
an output process in which the at least one processor outputs the effect amount, wherein
in the estimation process, the at least one processor estimates the effect amount for each predetermined classification; and
in the output process, the at least one processor distinguishably outputs, among the classifications, the effect amount of a classification that affects a balance sheet and the effect amount of a classification that affects an income statement.

### (Supplementary Note B5)

The information processing method according to any one of Supplementary Notes B1 to B4, wherein the current status information includes a part or all of a sales scale, a current stockout rate, a downward fluctuation composition ratio of demand, a cost rate, a production/procurement lead time, a storage related cost, a transportation related cost, and a labor related cost.

### (Supplementary Note B6)

The information processing method according to any one of Supplementary Notes B1 to B5, wherein the current status improvement information includes a part or all of an assumed improvement rate of a stockout and an assumed reduction rate of working time.

### [Supplementary Note C]

The present disclosure includes techniques described in the following supplementary notes. However, the present disclosure is not limited to the techniques described in the following supplementary notes, and various modifications can be made within the scope described in the claims.

### (Supplementary Note C1)

An information processing program for causing a computer to function as an information processing apparatus, the program causing the computer to function as:
a current status information acquisition means for acquiring current status information related to a current status of cost related to distribution of a product;
an assumed information acquisition means for acquiring assumed information including accuracy improvement information indicating a degree of improvement assumed for demand prediction accuracy regarding the product and current status improvement information indicating a degree of improvement assumed for the current status information; and
an estimation means for estimating an effect amount indicating an effect due to improvement in the demand prediction accuracy as an amount of money based on the current status information and the assumed information.

### (Supplementary Note C2)

The information processing program according to Supplementary Note C1 causing the computer to further function as an output means for outputting the effect amount, wherein
the accuracy improvement information includes an assumed improvement rate assumed for the demand prediction accuracy by each of a plurality of actions that can be performed for improving the demand prediction accuracy;
the estimation means estimates the effect amount for each of the plurality of actions; and
the output means outputs a breakdown of the effect amount based on the plurality of actions.

### (Supplementary Note C3)

The information processing program according to Supplementary Note C1 or C2 causing the computer to further function as an output means for outputting the effect amount, wherein
the effect includes, as a plurality of effects, a part or all of an effect due to reducing an opportunity loss, an effect due to reducing an inventory, an effect due to reducing a storage/distribution cost, and an effect due to improving operation efficiency;
the estimation means estimates the effect amount for each of the plurality of effects; and
the output means outputs a breakdown of the effect amount based on the plurality of effects.

### (Supplementary Note C4)

The information processing program according to any one of Supplementary Notes C1 to C3 causing the computer to further function as an output means for outputting the effect amount, wherein
the estimation means estimates the effect amount for each predetermined classification; and
the output means distinguishably outputs, among the classifications, the effect amount of a classification that affects a balance sheet and the effect amount of a classification that affects an income statement.

### (Supplementary Note C5)

The information processing program according to any one of Supplementary Notes C1 to C4, wherein the current status information includes a part or all of a sales scale, a current stockout rate, a downward fluctuation composition ratio of demand, a cost rate, a production/procurement lead time, a storage related cost, a transportation related cost, and a labor related cost.

### (Supplementary Note C6)

The information processing program according to any one of Supplementary Notes C1 to C5, wherein the current status improvement information includes a part or all of an assumed improvement rate of a stockout and an assumed reduction rate of working time.

### [Supplementary Note D]

The present disclosure includes techniques described in the following supplementary notes. However, the present disclosure is not limited to the techniques described in the following supplementary notes, and various modifications can be made within the scope described in the claims.

### (Supplementary Note D1)

An information processing apparatus including at least one processor, wherein the at least one processor executes:
a current status information acquisition process for acquiring current status information related to a current status of cost related to distribution of a product;
an assumed information acquisition process for acquiring assumed information including accuracy improvement information indicating a degree of improvement assumed for demand prediction accuracy regarding the product and current status improvement information indicating a degree of improvement assumed for the current status information; and
an estimation process for estimating an effect amount indicating an effect due to improvement in the demand prediction accuracy as an amount of money based on the current status information and the assumed information.

The information processing apparatus may further include a memory. The memory may store a program for causing the at least one processor to execute each of the processing.

### (Supplementary Note D2)

The information processing apparatus according to Supplementary Note D1, wherein:
the at least one processor further executes an output process for outputting the effect amount;
the accuracy improvement information includes an assumed improvement rate assumed for the demand prediction accuracy by each of a plurality of actions that can be performed for improving the demand prediction accuracy;
in the estimation process, the at least one processor estimates the effect amount for each of the plurality of actions; and
in the output process, the at least one processor outputs a breakdown of the effect amount based on the plurality of actions.

### (Supplementary Note D3)

The information processing apparatus according to Supplementary Note D1 or D2, wherein:
the at least one processor further executes an output process for outputting the effect amount;
the effect includes, as a plurality of effects, a part or all of an effect due to reducing an opportunity loss, an effect due to reducing an inventory, an effect due to reducing a storage/distribution cost, and an effect due to improving operation efficiency;
in the estimation process, the at least one processor estimates the effect amount for each of the plurality of effects; and
in the output process, the at least one processor outputs a breakdown of the effect amount based on the plurality of effects.

### (Supplementary Note D4)

The information processing apparatus according to any one of Supplementary Notes D1 to D3, wherein:
the at least one processor further executes an output process for outputting the effect amount;
in the estimation process, the at least one processor estimates the effect amount for each predetermined classification; and
in the output process, the at least one processor distinguishably outputs, among the classifications, the effect amount of a classification that affects a balance sheet and the effect amount of a classification that affects an income statement.

### (Supplementary Note D5)

The information processing apparatus according to any one of Supplementary Notes D1 to D4, wherein the current status information includes a part or all of a sales scale, a current stockout rate, a downward fluctuation composition ratio of demand, a cost rate, a production/procurement lead time, a storage related cost, a transportation related cost, and a labor related cost.

### (Supplementary Note D6)

The information processing apparatus according to any one of Supplementary Notes D1 to D5, wherein the current status improvement information includes a part or all of an assumed improvement rate of a stockout and an assumed reduction rate of working time.

### [Supplementary Note E]

The present disclosure includes techniques described in the following supplementary notes. However, the present disclosure is not limited to the techniques described in the following supplementary notes, and various modifications can be made within the scope described in the claims.

### (Supplementary Note E1)

A non-transitory storage medium storing an information processing program for causing a computer to function as an information processing apparatus, the program causing the computer to function as:
a current status information acquisition process for acquiring current status information related to a current status of cost related to distribution of a product;
an assumed information acquisition process for acquiring assumed information including accuracy improvement information indicating a degree of improvement assumed for demand prediction accuracy regarding the product and current status improvement information indicating a degree of improvement assumed for the current status information; and
an estimation process for estimating an effect amount indicating an effect due to improvement in the demand prediction accuracy as an amount of money based on the current status information and the assumed information.

1. An information processing apparatus comprising:
at least one memory storing instructions; and
at least one processor configured to execute the instructions to:
acquire current status information related to a current status of cost related to distribution of a product;
acquire assumed information including accuracy improvement information indicating a degree of improvement assumed for demand prediction accuracy regarding the product and current status improvement information indicating a degree of improvement assumed for the current status information; and
estimate an effect amount indicating an effect due to improvement in the demand prediction accuracy as an amount of money based on the current status information and the assumed information.

2. The information processing apparatus according to claim 1, wherein the at least one processor is further configured to execute the instructions to:
acquire the accuracy improvement information including an assumed improvement rate assumed for the demand prediction accuracy by each of a plurality of actions that can be performed for improving the demand prediction accuracy;
estimate the effect amount for each of the plurality of actions; and
output a breakdown of the effect amount based on the plurality of actions.

3. The information processing apparatus according to claim 1, wherein the at least one processor is further configured to execute the instructions to:
estimate the effect amount for each of a plurality of effects, the plurality of effects including, a part or all of an effect due to reducing an opportunity loss, an effect due to reducing an inventory, an effect due to reducing a storage/distribution cost, and an effect due to improving operation efficiency; and
output a breakdown of the effect amount based on the plurality of effects.

4. The information processing apparatus according to claim 1, wherein the at least one processor is further configured to execute the instructions to:
estimate the effect amount for each predetermined classification; and
distinguishably output, among the classifications, the effect amount of a classification that affects a balance sheet and the effect amount of a classification that affects an income statement.

5. The information processing apparatus according to claim 1, wherein the current status information includes a part or all of a sales scale, a current stockout rate, a downward fluctuation composition ratio of demand, a cost rate, a production/procurement lead time, a storage related cost, a transportation related cost, and a labor related cost.

6. The information processing apparatus according to claim 1, wherein the current status improvement information includes a part or all of an assumed improvement rate of a stockout and an assumed reduction rate of working time.

7. The information processing apparatus according to claim 1, wherein the at least one processor is further configured to execute the instructions to:
estimate the effect amount using a machine learning model trained to predict financial effects based on the current status information and the assumed information; and
output decision making support information that identifies which actions provide optimal return on investment for improving demand prediction accuracy.

8. An information processing method comprising:
acquiring current status information related to a current status of cost related to distribution of a product;
acquiring assumed information including accuracy improvement information indicating a degree of improvement assumed for demand prediction accuracy regarding the product and current status improvement information indicating a degree of improvement assumed for the current status information; and
estimating an effect amount indicating an effect due to improvement in the demand prediction accuracy as an amount of money based on the current status information and the assumed information.

9. The information processing method according to claim 8, further comprising:
acquiring the accuracy improvement information including an assumed improvement rate assumed for the demand prediction accuracy by each of a plurality of actions that can be performed for improving the demand prediction accuracy;
estimating the effect amount for each of the plurality of actions; and
outputting a breakdown of the effect amount based on the plurality of actions.

10. The information processing method according to claim 8, further comprising:
estimating the effect amount for each of a plurality of effects, the plurality of effects including, a part or all of an effect due to reducing an opportunity loss, an effect due to reducing an inventory, an effect due to reducing a storage/distribution cost, and an effect due to improving operation efficiency; and
outputting a breakdown of the effect amount based on the plurality of effects.

11. The information processing method according to claim 8, further comprising:
estimating the effect amount for each predetermined classification; and
distinguishably outputting, among the classifications, the effect amount of a classification that affects a balance sheet and the effect amount of a classification that affects an income statement.

12. The information processing method according to claim 8, wherein the current status information includes a part or all of a sales scale, a current stockout rate, a downward fluctuation composition ratio of demand, a cost rate, a production/procurement lead time, a storage related cost, a transportation related cost, and a labor related cost.

13. The information processing method according to claim 8, wherein the current status improvement information includes a part or all of an assumed improvement rate of a stockout and an assumed reduction rate of working time.

14. The information processing method according to claim 8, further comprising:
estimating the effect amount using a machine learning model trained to predict financial effects based on the current status information and the assumed information; and
outputting decision making support information that identifies which actions provide optimal return on investment for improving demand prediction accuracy.

15. A non-transitory computer-readable recording medium storing a program causing a computer to execute processing comprising:
acquiring current status information related to a current status of cost related to distribution of a product;
acquiring assumed information including accuracy improvement information indicating a degree of improvement assumed for demand prediction accuracy regarding the product and current status improvement information indicating a degree of improvement assumed for the current status information; and
estimating an effect amount indicating an effect due to improvement in the demand prediction accuracy as an amount of money based on the current status information and the assumed information.

16. The non-transitory computer-readable recording medium according to claim 15, further storing a program causing the computer to execute processing comprising:
acquiring the accuracy improvement information including an assumed improvement rate assumed for the demand prediction accuracy by each of a plurality of actions that can be performed for improving the demand prediction accuracy;
estimating the effect amount for each of the plurality of actions; and
outputting a breakdown of the effect amount based on the plurality of actions.

17. The non-transitory computer-readable recording medium according to claim 15, further storing a program causing the computer to execute processing comprising:
estimating the effect amount for each of a plurality of effects, the plurality of effects including, a part or all of an effect due to reducing an opportunity loss, an effect due to reducing an inventory, an effect due to reducing a storage/distribution cost, and an effect due to improving operation efficiency; and
outputting a breakdown of the effect amount based on the plurality of effects.

18. The non-transitory computer-readable recording medium according to claim 15, further storing a program causing the computer to execute processing comprising:
estimating the effect amount for each predetermined classification; and
distinguishably outputting, among the classifications, the effect amount of a classification that affects a balance sheet and the effect amount of a classification that affects an income statement.

19. The non-transitory computer-readable recording medium according to claim 15, wherein the current status information includes a part or all of a sales scale, a current stockout rate, a downward fluctuation composition ratio of demand, a cost rate, a production/procurement lead time, a storage related cost, a transportation related cost, and a labor related cost.

20. The non-transitory computer-readable recording medium according to claim 15, further storing a program causing the computer to execute processing comprising:
estimating the effect amount using a machine learning model trained to predict financial effects based on the current status information and the assumed information; and
outputting decision making support information that identifies which actions provide optimal return on investment for improving demand prediction accuracy.
